(19) United States
(12) Patent Application Publication
(10) Pub. No.: US 2008/0233391 A1
(43) Pub. Date: Sep. 25, 2008

(54) Photonic Crystals for Thermal Insulation

(75) Inventors: Hans-Josef Sterzel, Dannstadt-Schauernheim (DE); Klaus Kuhling, Ellerstadt (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (DE)

(21) Appl. No.: 12/089,286

(22) PCT Filed: Sep. 29, 2006
(86) PCT No.: PCT/EP2006/066867

§ 371 Date: Apr. 4, 2008

(30) Foreign Application Priority Data
Oct. 4, 2005 (DE) 102005047605.8

(51) Int. Cl. B32B 5/16

(52) U.S. Cl. 428/339; 428/332

(57) ABSTRACT

The invention relates to photonic crystals which have units having a refractive index of greater than 3 and units having a refractive index of less than 1.6 in a periodic sequence and separations of the individual units of from 1 to 20 μm, and also to the use of these photonic crystals.

Photonic crystals consist of a periodic arrangement of materials with different refractive indices. Like atomic crystals or ionic crystals, they have a regular lattice structure with a high degree of periodicity and long-range order. The peculiarity of photonic crystals lies in the periodic modulation of the refractive index. Depending on the arrangement, a distinction is drawn between one-, two- and three-dimensional structures. Owing to the three-dimensional periodic arrangement, the latter are often referred to as photonic crystals. The naming is based on atomic structures, with the difference that it is not atoms, molecules or ions in a crystal that take up certain lattice positions, but rather that there is a similar arrangement of points with high long-range order in three-dimensional space, which differ by their refractive index. In analogy to ionic crystals or molecular crystals, the terms lattice sites, lattice planes and unit cell are also used. Generally, they are thus multilayer structures which have a periodic structure which accompanies a periodic modulation of the refractive index at least within one layer. Preference is given to those structures which also have periodic long-range order from layer to layer, i.e. have a three-dimensionally periodic structure.

When the lattice spacings are in the region of the wavelengths of visible light, visible optical effects such as absorption or reflection of certain wavelengths are obtained. Natural opal is an example of photonic crystals. An overview is given by the article “Photonische Kristalle”, Physikalische Blätter 55 (1999) No. 4, 27-33.

According to this, the shape of the materials with different refractive index is of little importance; what is important is a high periodicity of the arrangement and a maximum refractive index difference. For instance, the materials may be layered as rods with constant separation or be arranged in a honeycomb-like manner; a punctiform expansion of the regions with different refractive index is thus not necessarily a prerequisite.

Such structures are produced on the ultrasmall scale by means of the photolithographic methods known from microelectronics, such as illumination, development and etching (“On-chip natural assembly of silicon photonic bandgap crystals”, Nature, Vol. 414, Nov. 15, 2001, 289-293.).

The periodicity brings about a bandgap, as a result of which electromagnetic waves whose energy is within the order of magnitude of the bandgap cannot spread in the material and are reflected fully. The position and size of the bandgap depends upon the type and arrangement of the materials which cause the bandgap owing to their different refractive index.

Thus, it was possible to produce a metallic photonic crystal from tungsten, from rods of width 1.2 μm and a “lattice spacing” of 4.2 μm. When current passes through it, such a photonic crystal virtually no longer emits any thermal radiation; its passage through the crystal is forbidden (Nature, Vol. 417, 2 May 2002, 52-55; Spektrum der Wissenschaft, November 2002, 14-15).

For a complete bandgap, the refractive index difference between two materials should be greater than 2.5 (Δn>2.5). Particular preference is given to selecting materials which allow a Δn of >3. The size of the bandgap is calculated by comparing the proportion of radiation reflected by a component or a structure with the proportion of transmitted radiation. When the difference in the refractive indices is less than, for example, 2.5, a portion of the radiation is transmitted; this is then referred to as an incomplete bandgap (for an overview see “Photonic Crystals: Molding the Flow of Light”, Princeton University Press, 1995).

The number of layers required to achieve a complete bandgap depends upon various factors, such as type of materials, geometry of the periodic structure, perfection of the long-range order, thickness of the layers, etc. In general, 4-40 layers are required; preference is given to from 8 to 20 layers.

Hence, photonic crystals with lattice spacings in the region of the wavelength of thermal radiation, i.e. of 1-20 μm, enable outstanding thermal insulation even in low layer thicknesses.

However, the production of the structures is restricted to small areas or volumes owing to the costly and inconvenient photolithographic processes. Typically, such processes are employed for the production of structures for microelectronics in wafer size (i.e. diameter of the substrate up to a maximum of approx. 30 cm).

It was thus an object of the invention to provide photonic materials for thermal insulation, which can be produced with large surface areas and volumes by economically viable processes.

This object is achieved by various measures.

Generally, periodic structures with maximum refractive index difference are obtained by means of various processes.

To this end, materials with maximum refractive index are used. These are either metals or inorganic compounds. Organic materials all have a very much lower refractive index. Organic molecules all have refractive indices in the order of magnitude of from 1.0 to 1.4; polysubstituted and iodine-containing aromatics may have a refractive index of up to 1.6. Likewise known are organic polymers having a maximum refractive index of 1.6 (Handbook of optical constants of solids III, Academic Press 1998, ISBN 0-12-544423-0).

Useful inorganic compounds are mainly metals in elemental form (e.g. Al, Cu, Ag, Au, Zn) or semiconductors such as Si, Ge, ZnSe, ZnO, and also metal sulfides, which exhibit high refractive indices at wavelengths in the range from 1 to 25 μm, for example antimony trisulfide (n=4.1), lead sulfide (n=4.1), tin sulfide (n=3.6), iron sulfide FeS₂ (n=4.6) or molybdenum disulfide (n=5). At 10 μm, silicon has a refractive index of 3.4, Ge 4.0 and ZnSe 2.8, these materials being highly transparent in the wavelength range around 10 μm. Elemental metals generally have a very high refractive index (n>10). ZnO has a low refractive index in the region of visible light and a very high refractive index in the region of thermal radiation. Thus, optically transparent structures are also conceivable. (Handbook of optical constants of solids III, Academic Press 1998, ISBN 0-12-544423-0).

### Process 1

One process for preparing the inventive crystals consists in producing highly monodisperse polymer particles in the size range of diameter from 2 to 20 μm, blending these suspensions with very finely divided inorganic metal and/or metal sulfide particles in the size range of from 5 to 500 nm, bringing these blends onto a substrate, for example a film, and allowing the suspension to dry out thereon, if appropriate in the presence of small amounts of adhesive. In the course of this, the monodisperse polymer particles become ordered regularly in a lattice structure, and the interstitial volume is filled partly by the inorganic particles. A photonic lattice whose lattice spacing is determined by the size of the polymer particles is thus obtained.

Techniques for the production of monodisperse particles in the 10 μm range are known and do not form part of the subject matter of the invention (see, for example, “Synthesis of greater than 10 μm size, monodispersed polymer particles by one-step seeded polymerization for highly monomer-swollen polymer particles prepared utilizing the dynamic swelling method”, J. Appl. Polym. Sci, Vol. 74 (1999), 278-285). For these experiments, particularly polystyrene spheres are suitable. Metal sulfide particles can be produced, for example, by precipitation reactions. For instance, PbS is obtained by passing H₂S into a lead salt solution, for example lead acetate, in water.

### Process 2

A further process for producing large surfaces of photonic structures consists in applying metals, for example aluminum, by vapor deposition to carrier films of polymers, for example polyethylene terephthalate, through a mask to obtain an ordered two-dimensional lattice structure of the metal. The mask can be obtained by photolithographic processes or by other well-known techniques, for example punching.

Subsequently, vapor deposition is effected over the full surface with a material having a low refractive index, for example SiOₓ. The metal vapor deposition through the mask is then repeated, then again the full-surface vapor deposition with SiOₓ. A total of from 2 to 20 structured metal layers are obtained. Instead of a repetition of the vapor deposition step, it is also possible to subject the film, once structured, to vapor deposition, then to cut it into pieces and to position and fix different layers of film one on top of the other in accordance with the intended structure, for example by lamination. It is thus possible to produce ordered structures in substantially larger formats than is possible by means of conventional wafer technology. It is possible to produce films which are suitable, for example, for lining facades, floors or windows. The process sequence itself is known and is practiced to obtain nonphotonic structures.

It is also possible to emboss a polymer film by means of appropriately structured metal die, if appropriate at a temperature below the melting point but above the glass softening temperature of the polymer, and to metallize the film thus structured, preferably by means of aluminum. The film thickness is from 5 to 20 μm, the thickness of the metallization layer from 0.2 to 2 μm. CDs are produced in a similar manner; the structures embossed into plastic there (pits) typically have a width of 0.5 μm, depth of 0.11 μm and a length in the range from 0.8 μm to approx. 3.6 μm. Structured carrier films can also be produced in other ways, for example by utilizing demixing effects or the like.

It is also possible to work without carrier films and to introduce round or angular holes or slots at a constant distance of from 2 to 20 μm directly into thin metal films of thickness from 1 to 20 μm by punching or etching. In this case, an appropriately structured punching tool whose structure is always transferred into the film has to be produced. The process sequence itself is known and is practiced to obtain nonphotonic structures. The cavities are, for example, filled with air which fulfills the function of the low-refractivity component. Stacks of from 2 to 50 of these films afford large-surface area photonic crystals.

Since the orifices in the metal films do not have to be continuous to achieve the effect, it is also possible to obtain the photonic crystals by embossing the metal foils. As in the case of embossing a polymer film and of punching (see above), it is necessary only once to produce an appropriately structured die. This can be done, for example, by photolithographic processes or other techniques for microstructuring. The die may find use in roller form, so that the structuring is effected in a particularly inexpensive manner and with high throughput by pressing the carrier material against this roller.

It is also possible to punch holes of any shape—circular, elliptical, rod-shaped—into polymer films of thickness from 2 to 20 μm at a separation of from 2 to 20 μm, and subsequently to fill these holes with a finely divided dispersion of the metal, semiconductor or metal sulfide powder. Stacking of such films one on top of the other likewise affords photonic crystals.

### Process 3

A further means of producing large-surface area photonic crystals is offered by the printing technique. Processes are known from banknote printing, for example, which can print structures on with sufficiently high resolution.

Metal, semiconductor and/or sulfide powder is imprinted onto a substrate, for example a polymer film, such that a two-dimensional photonic layer is obtained. A paste of a highly porous material which has a minimum refractive index owing to the porosity is then spread, for example a paste based on very finely divided highly porous SiO₂. After this layer has dried on, a further photonic layer of metal and/or sulfide powder is printed on and the process is continued until up to from 20 to 30 layers and hence a three-dimensional photonic crystal has been obtained.

Irrespective of the various production processes of three-dimensional photonic crystals, the outer surface is, if appropriate, protected from environmental influences by a polymer or coating layer.

The photonic crystals according to the invention have the advantageous property combination of preventing thermal transport into and through the material to a high degree at very low thicknesses below 1 millimeter. Depending on the type, position and size of the bandgap, thermal transport by radiation is prevented by over 80%, more preferably to an extent of over 90%.

The photonic crystals are used to thermally insulate buildings or building parts, vehicles of any type, appliances whose thermal radiation would be troublesome (for example ovens), refrigeration units of any type, or as an intermediate layer in textiles of any type, in particular when they are exposed to high thermal radiation, for example firefighters' suits.

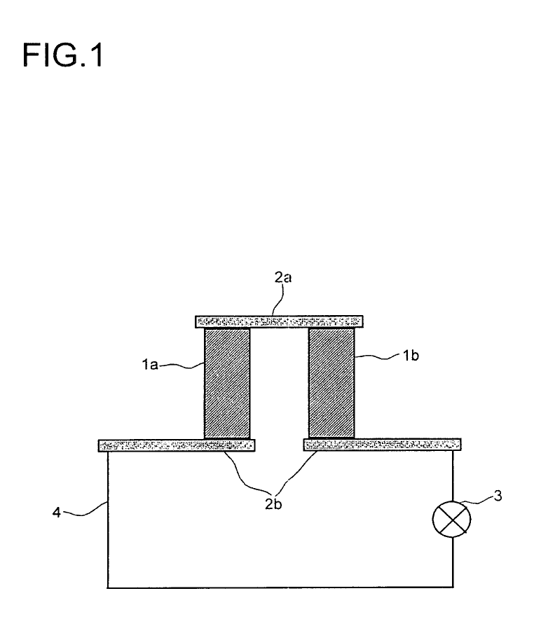

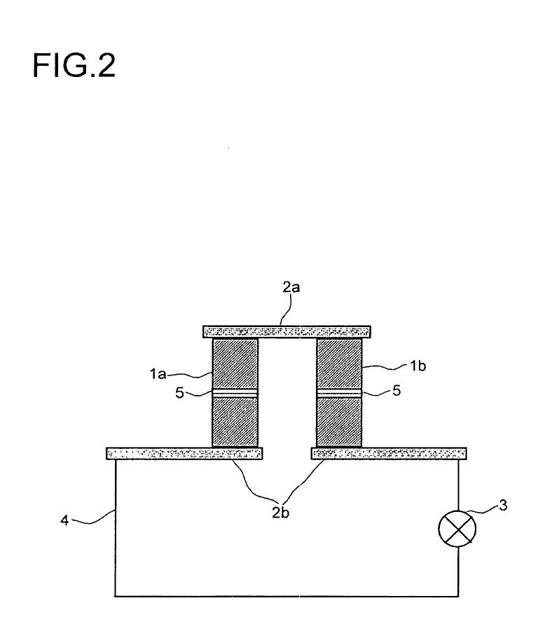

Electrically conductive photonic crystals may be used in order to thermally separate the hot and the cold side of thermoelectric converters from one another and thus to greatly improve their efficiencies. Thermoelectric modules are described in detail, for example, in CRC Handbook of Thermoelectrics, CRC Press 1995, ISBN 0-8493-0146-7, p. 597-607. By means of thermoelectric modules, the intention is either to form a temperature difference through current flow or to generate a current flow through an external temperature difference. In both cases, a low thermal conductivity of the thermoelectrically active material is a prerequisite to maintain the temperature difference or to simplify the maintenance of the temperature difference. The incorporation of the inventive structures into the thermoelectric material greatly reduces the parasitic conduction of heat. This leads to greatly improved efficiencies on the overall thermoelectric component; cf. FIGS. 1 and 2.

FIG. 1:

Schematic structure of a customary thermoelectric converter. In commercial modules, many n-p semiconductor pairs are connected electrically in series in order to achieve higher voltages.

FIG. 2:

Schematic structure of a modified thermoelectric converter. Materials having a bandgap in the region of thermal radiation have been integrated into the middle of the thermoelectrically active materials. This reduces the (parasitic) conduction of heat between hot and cold side and distinctly increases the overall efficiency.

### REFERENCE NUMERAL LIST

1 semiconductor
1a n-semiconductor
1b p-semiconductor
2 electrical conductor, e.g. Cu
2a hot side
2b cold side
3 electrical load or current source
4 circuit
5 electrically conductive photonic crystals with bandgap in the region of thermal radiation

1. A photonic crystal which has units having a refractive index of greater than 3 and units having a refractive index of less than 1.6 in a periodic sequence and separations of the individual units of from 1 to 20 μm, in which units having a refractive index of less than 1.6 and a diameter of from 2 to 20 μm reside at lattice sites and particles of a diameter of from 0.1 to 1 μm and a refractive index of greater than 3 reside at the interstitial lattice sites and the particles having low refractive index are air bubbles or consist of organic polymers, metal oxides or nonmetal oxides.

2. The photonic crystal according to claim 1, wherein the particles consist of organic polymers.

3. The photonic crystal according to claim 2, wherein the particles consist of polystyrene or a polystyrene copolymer.

4. The photonic crystal according to claim 1, wherein the particles having high refractive index are Si, Ge, ZnSe, ZnO, metal powder or metal sulfide powder.

5. The photonic crystal according to claim 1, obtainable
i) by applying units having refractive index of less than 1.6 to a carrier film in a separation of from 2 to 20 μm by means of a mask,
ii) shifting the mask by the abovementioned distance and
iii) applying units having refractive index of greater than 3 in the interstices which have formed by the application i).

6. The photonic crystal according to claim 5, wherein operations i) to iii) are repeated from 2 to 20 times, or the coated film is cut into pieces and from 2 to 20 layers of the coated film are positioned and fixed one on top of the other.

7. The photonic crystal according to claim 5, wherein the different units are applied by vapor deposition.

8. The photonic crystal according to claim 1, wherein the different units are applied by printing processes.

9. The photonic crystal according to claim 5, wherein the different units are applied by printing processes.

10. The photonic crystal according to claim 1, obtainable by
i) embossing a film of thickness from 5 to 20 μm and of refractive index less than 1.6 and
ii) metallizing with a layer of thickness from 0.2 to 2 μm.

11. The photonic crystal according to claim 1, obtainable by
i) punching or etching a metal film of thickness from 1 to 20 μm at a periodic distance of from 2 to 20 μm and
ii) positioning and fixing from 2 to 20 layers of this film one on top of the other.

12. (canceled)

13. The photonic crystal according to claim 2, wherein the particles having high refractive index are Si, Ge, ZnSe, ZnO, metal powder or metal sulfide powder.

14. The photonic crystal according to claim 6, wherein the different units are applied by vapor deposition.

15. The photonic crystal according to claim 6, wherein the different units are applied by printing processes.

16. A building or building part comprising photonic crystals of claim 1 wherein as thermal insulation.

17. A vehicle comprising photonic crystals according to claim 1 as thermal insulation.

18. An appliance comprising photonic crystals according to claim 1 as thermal insulation.

19. A refrigeration unit comprising photonic crystals according to claim 1 as thermal insulation.

20. A textile comprising photonic crystals according to claim 1 as thermal insulation.

21. A thermoelectric converter comprising photonic crystals according to claim 1 as thermal insulation.
